(19) United States
(12) Patent Application Publication
(10) Pub. No.: US 2022/0174675 A1
(43) Pub. Date: Jun. 2, 2022

(54) METHODS FOR SOLICITING A TRIGGER BASED (TB) PHYSICAL LAYER CONVERGENCE PROTOCOL DATA UNIT (PPDU) AND APPARATUS FOR PERFORMING THE METHODS

(71) Applicant: NXP USA, Inc., Austin, TX (US)

(72) Inventors: Liwen Chu, San Ramon, CA (US); Rui Cao, Sunnyvale, CA (US); Young Hoon Kwon, Laguna Niguel, CA (US); Hongyuan Zhang, Fremont, CA (US); Huiling Lou, Sunnyvale, CA (US)

(21) Appl. No.: 17/538,643

(22) Filed: Nov. 30, 2021

Related U.S. Application Data
(60) Provisional application No. 63/119,108, filed on Nov. 30, 2020.
(60) Provisional application No. 63/160,329, filed on Mar. 12, 2021.

(51) Int. Cl. H04W 72/04; H04L 29/06

(52) U.S. Cl. CPC H04W 72/0453; H04W 88/08; H04L 69/22

(57) ABSTRACT

A first data unit is transmitted which indicates to a remote device to transmit a second data unit. The first data unit comprises an indication to transmit a second data unit. The first data unit comprises a value which indicates that the remote device is to transmit the second data unit and does not indicate a protocol which defines a format of the second data unit. The protocol which defines the format of the second data unit is based on a protocol which defines a format of the first data unit. The second data unit is received from the remote device in response to the transmission of the first data unit.

### RELATED APPLICATION

This application claims a benefit of priority to U.S. Provisional Application No. 63/119,108, entitled “TRS for EHT TB PPDU and Future Generation of TB PPDU” filed Nov. 30, 2020 and U.S. Provisional Application No. 63/160,329, entitled “Trigger and OFDMA Random Access” filed Mar. 12, 2021, the contents each of which are incorporated herein by reference in their entireties.

### FIELD OF USE

This disclosure generally relates to wireless communication, and more particularly to methods for soliciting trigger based (TB) physical layer convergence protocol data unit (PPDU) and apparatus performing the methods based on a trigger response scheduling process (TRS) or an extremely high throughput (EHT) trigger frame announcing random resource unit (RU) access for transmitting the TB PPDU.

### BACKGROUND

When operating in an infrastructure mode, wireless local area networks (WLANs) typically include an access point (AP) and one or more client stations. Wireless local area networks (WLANs) have evolved rapidly over the past decade. Development of WLAN standards such as the Institute for Electrical and Electronics Engineers (IEEE) 802.11a, 802.11b, 802.11g, 802.11n, and 802.11ax has improved single user peak data throughput in the WLAN. Work continues on newer revisions to these standards including 802.11be that promises to provide even greater throughput.

### BRIEF DESCRIPTION OF THE DRAWINGS

FIG. 1 is an example block diagram of an example communication system having one or more devices such as access point (AP) and one or more non-AP stations (STAs) to communicate data units in an downlink (DL) direction from the AP to non-AP STA and in an uplink (UL) direction from the non-AP to the AP in accordance with an embodiment.

FIG. 2 is an example diagram which illustrates an example solicitation of a trigger based (TB) physical layer convergence protocol data unit (PPDU) from an STA in accordance with an embodiment.

FIGS. 3A & 3B are flow charts of example functions for soliciting a TB PPDU from an STA in accordance with an embodiment.

FIGS. 4A & 4B are a flow charts of alternative example functions associated with soliciting a TB PPDU from an STA in accordance with an embodiment.

FIGS. 5A & 5B are flow charts of example functions associated with soliciting a PPDU which is not a TB PPDU in accordance with an embodiment.

FIG. 6 illustrates an example trigger frame which is transmitted to solicit the TB PPDU in accordance with an embodiment.

FIG. 7 illustrates an example operation of STAs which randomly accesses resource units (RUs) in accordance with an embodiment.

FIG. 8 illustrates an example operation of an unassociated STA which receives a unicast association response with a trigger and transmits an acknowledgement to the association response in accordance with an embodiment.

FIG. 9 is a flow chart of example functions associated with soliciting a TB PPDU based on the trigger frame in accordance with an embodiment.

The drawings are for the purpose of illustrating example embodiments, but it is understood that the embodiments are not limited to the arrangements and instrumentality shown in the drawings.

### DETAILED DESCRIPTION

An access point (AP) transmits data units to one or more client stations in a downlink (DL) direction to a non-AP client station (STA). The data units from the AP comprise one or more physical layer convergence protocol data units (PPDUs). The STA also transmits data units in an uplink (UL) direction to the AP. The data units from the STA also comprise one or more PPDUs.

Embodiments disclosed herein are directed to transmitting a PPDU from the AP to the STA including one of a trigger frame, data frame, or management frame. In one example, the data frame or management frame has a media access control (MAC) header which includes a trigger based scheduling (TRS) control subfield with a control information field. The control information field includes a control identifier (ID) that explicitly or implicitly indicates that the AP is soliciting a PPDU from the STA with a particular format defined by a protocol. The PPDU solicited is a trigger based (TB) PPDU which is formatted based on an extremely high throughput (EHT) protocol or next generation (NG) protocol. In another example, the trigger frame has an AID12 value in an AID12 subfield of a user information field which explicitly indicates that an EHT TB PPDU is solicited and announces random selection of a resource unit (RU) to transmit the TB PPDU. Well known instructions, protocols, structures, and techniques have not been shown in detail in order not to obfuscate the description.

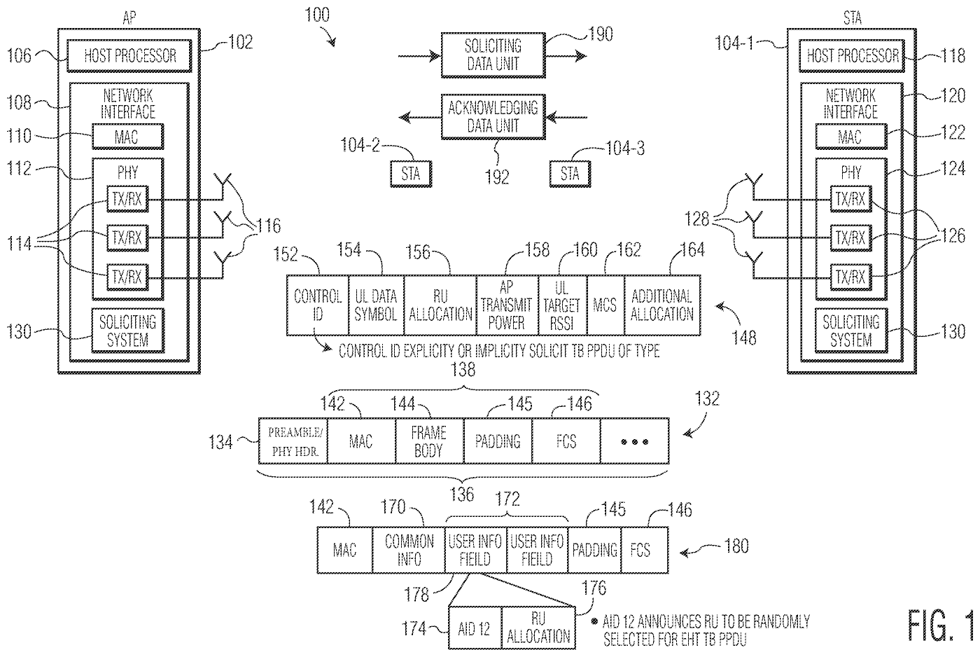

FIG. 1 is an example block diagram of an example communication system 100 having one or more devices such as AP 102 and one or more non-AP STAs shown as non-AP STA 104-1 to 104-3 to communicate data units in an downlink (DL) direction from the AP 102 to non-AP STA 104-1 to 104-3 and in an uplink (UL) direction from the non-AP 104-1 to 104-3 to the AP 102 in accordance with an embodiment. The AP 102 is a device that allows other WiFi devices (e.g., client stations 104) to wirelessly connect to a wired network (not shown). The AP 102 and one or more non-AP STAs 104-1, 104-2, 104-3 exchange information based on one or more of a multiple user (MU) or single user (SU) multiple-input and multiple-output (MIMO) technique that exploits multipath propagation of signals between the AP 102 and non-AP STAs 104-1, 104-2, 104-3 and an orthogonal frequency division multiple access (OFDMA) protocol where a channel bandwidth between the AP 102 and non-AP STA 104-1 to 104-3 is divided into a plurality of orthogonal subcarriers. One or more of the AP 102 and non-AP STA 104-1 to 104-3 may use a group of the plurality of orthogonal subcarriers referred to as a resource unit (RU) for DL or UL transmission of data between the AP 102 and the non-AP STAs 104-1 to 104-3 over the channel bandwidth.

In an example, the AP 102 includes a host processor 106 coupled to a network interface 108. The network interface 108 includes a medium access control (MAC) unit 110 and a physical layer (PHY) unit 112. The PHY unit 112 includes one or more transceivers 114 each coupled to a respective antenna 116 spatially separated from each other. The transceiver 114 may function as a transmitter or a receiver. In general, the AP 102 may include N transceivers and N antenna where N=3, but N could be a different number (e.g., 1, 2, 4, 5, 6, etc.) in other examples. The MAC unit 110 and the PHY unit 112 may be configured to operate according to a communication protocol generally similar to the IEEE 802.11 standard, for example, such as extremely high throughput (EHT) 802.11be protocol and next generation (NG) EHT 802.11 referred to also as WiFi 8 protocol.

The communication system 100 includes a plurality of non-AP STA shown as 104-1 to 104-3. Although three non-AP STAs 104-1 to 104-3 are illustrated in FIG. 1, the communication system 100 can include different numbers (e.g., 1, 2, 3, 4, 5, 6, etc.) of non-AP STA 104 in various embodiments.

The non-AP STA 104-1 includes a host processor 118 coupled to a network interface 120. The network interface 120 includes a MAC unit 122 and a PHY unit 124. The PHY unit 124 includes one or more transceivers 126 coupled to a respective antennas 128.

In various embodiments, the AP 102 or STA 104-1 to 104-3 may have a soliciting system 130 which generates a soliciting data unit 190 which solicits an acknowledging data unit 192 also referred to as a solicited data unit. The data units 190, 192 may comprise one or more fields defined by one or more bits in an example. The data unit 190, 192 may be a PPDU 132. A format of the PPDU 132 may be defined by particular protocol such as high efficiency (HE) of 802.11ax protocol, EHT, or NG EHT to be an HE PPDU, EHT PPDU, or NG EHT PPDU respectively. The AP 102 may solicit an acknowledgement from the STA 104-1 to 104-3 and the STA 104-1 to 104-3 may solicit an acknowledgement from the AP 102. The PPDU 132 may have a preamble/header portion 134 which carries one or more of a short training field, long training field patterns, signaling (SIG) fields, and physical layer (PHY) header and a data portion 136 which carries one or more frames, an example of which is frame 138. The frame 138 may have a plurality of fields 142-146 which include a media access control (MAC) field 142, frame body 144, a padding field 145, and a frame check sequence (FCS) 146.

The MAC field 142 may define parameters associated with transmission and receipt of frames in a network. The frame body 144 may carry data or control information associated with operation of an AP 102 or STA 104-1 to 104-3. The padding field 145 may include one or more bits or bytes so that a size of the frame 148 is a certain number of bytes in an example. The frame check sequence 146 is an error detecting code added to the PPDU 132.

A PPDU may solicit another PPDU. The solicited PPDU may be a trigger based (TB) PPDU and differ in format from the soliciting PPDU. In an example, fields or length of fields in the preamble/PHY header 134 such as signaling fields (SIG) training fields, and other fields in a TB PPDU may differ from corresponding fields of a PPDU which is not a TB PPDU. Further, the format of the TB PPDU may be defined by a protocol. An HE TB PPDU is a TB PPDU formatted in accordance with HE protocol. An EHT TB PPDU is a TB PPDU formatted in accordance with EHT protocol. An NG EHT TB PPDU is a TB PPDU formatted in accordance with NG EHT protocol.

The TB PPDU may be solicited in many ways. In one example, frame 138 may be a data frame or management frame and the MAC field 142 may have a TRS control subfield with a control information field 148 associated with a TRS process. The control information field 148 includes a control identifier field 152, uplink (UL) data symbols field 154, an RU allocation field 156, AP Tx power field 158, a UL target RSSI field 160, a modulation coding scheme (MCS) field 162, and an additional RU allocation field 164. The control identifier (ID) field 152 may indicate that the control information field 148 defines parameters associated with the IRS process. Further, a control ID value in the control ID field 152 may indicate that a trigger based (TB) PPDU or PPDU which is not a TB PPDU is solicited. In an example, the control ID value may indicate that the PPDU 132 is soliciting an EHT TB PPDU or NG EHT TB PPDU. The indication may be explicit if the control ID value (e.g., bits) indicates that the PPDU 132 is soliciting a TB PPDU and the control ID value itself indicates one of an EHT TB PPDU and HE TB PPDU is solicited. The indication is implicit if one or more fields in the soliciting PPDU other than the control ID value in the control information field 148 may need to be also considered with the control ID value to determine or indicate the protocol defining the format of the solicited TB PPDU. In the implicit indication, the protocol which defines the format of the soliciting PPDU 132 is determined. In an example, the PHY header 134 of the PPDU 132 may indicate the protocol defining the format of the soliciting PPDU 132. The protocol defining the format of PPDU 132 may further define the protocol defining the format the TB PPDU. As examples, a control information field 148 carried in an HE PPDU solicits a HE TB PPDU, a control information field 148 carried in an EHT PPDU solicits a EHT TB PPDU, and a control information field 148 carried in an NG-EHT PPDU solicits a NG-EHT TB PPDU. The UL data symbols field 154 indicates the number of OFDM symbols in a data field of the PPDU solicited. The RU allocation field 156 and the additional RU allocation field 164 may indicate the RU for the solicited PPDU which may be transmitted in a bandwidth up to 320 MHz associated with 802.11be. The AP transmit power field 154 may indicate a transmit power of the AP 102. The UL target received signal strength indicator (RSSI) 154 may be the RSSI at which the AP 102 desires to receive each non-AP STAs uplink transmission. The modulation coding scheme (MCS) field 162 may indicate an MCS such as one of MCS 0 to 3 to be used by the receiving STA. In another embodiment, the additional RU allocation 164 may be excluded if a primary 160 MHz indication for a scheduled STA in the soliciting PPDU is used for the scheduled STA's RU allocation of the solicited TB PPDU.

In another example, a trigger frame 180 may be defined to solicit a EHT TB PPDU. The trigger frame 180 may include the media access control (MAC) field 142, the frame body 144 with a common information field 170, a user information list field 172 with one or more user information fields 178, the padding field 145, and the FCS 146. The common information field 170 includes information common to each of the STAs to send a TB PPDU. The user information field 178 provides details on each client device participating in an UL OFDMA transmission or UL MU MIMO transmission including an association ID 12 (AID12) subfield 174 which may typically indicate the addressed STA and a RU Allocation subfield 176 which indicates the RU size (e.g., subchannel bandwidth) and location (e.g., frequency range) of the RU allocated for the addressed STA. In an example, the AID12 subfield 174 may be set with a value to explicitly indicate that the trigger frame 180 triggers solicitation of an HE TB PPDU or EHT TB PPDU and random selection of the RUs indicated in the user information field 178 to transmit the HE TB PPDU or EHT TB PPDU based on an OFDMA random access process as described in 802.11 ax and below.

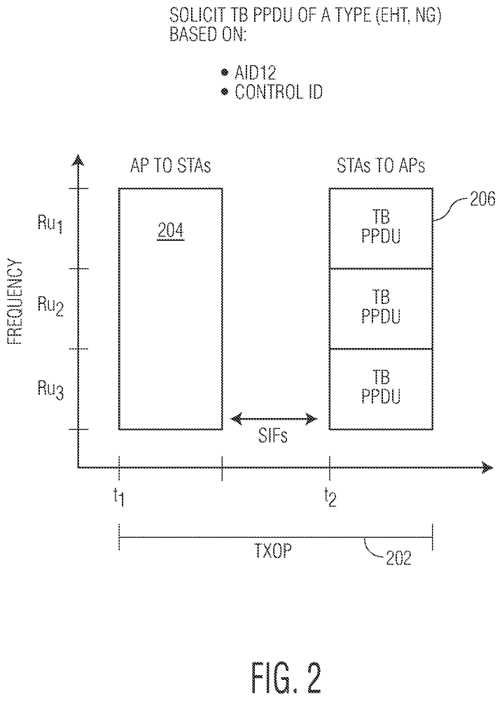

FIG. 2 is an example diagram 200 which illustrates an example solicitation of a TB PPDU of a format (e.g., EHT TB PPDU or NG EHT TB PPDU) by the trigger based soliciting system 130 in accordance with an embodiment. In an example, the AP 102 may trigger multiple STAs to perform an UL transmission during a transmission opportunity period (TXOP) 202.

During a time t₁, the AP 102 transmits a PPDU 204 to STAs with control information field 148 in MAC header of Data/Management frame, or a trigger frame, data frame or management frame (in addition to the data frame or management frame). The time t₁ begins at the beginning of a TXOP 202 obtained based on a suitable channel assessment procedure, such as carrier sensing and backoff. In one example, the control ID value of the control ID 152 field of the control information field 148 may indicate an TB PPDU 206 such as EHT TB PPDU or NG EHT TB PPDU is solicited and an RU associated with the TB PPDU 206 solicited. In another example, the AID12 value of the AID12 subfield 174 of a trigger frame 180 may indicates that an EHT TB PPDU is solicited and an RU may be randomly selected to transmit the EHT TB PPDU.

Time t₂ at each of the STAs begins upon expiration of a predetermined time interval, such as a time interval corresponding to a short inter-frame space (SIFS), after completion of reception of the PPDU 204 at the STA. The SIFS with additional padding field in soliciting PPDU may provide sufficient time for the STA to decode the control information field 148 of the PPDU 204 or AID12 of the trigger frame 180 and to prepare the TB PPDU 206 for UL transmission. In one example, the control ID 152 of the control information field 148 in the PPDU 204 may indicate that a respective STA is to transmit a solicited TB PPDU 206 during the time t₂ in a respective RU allocated to the STA as indicated in the PPDU 204. In an example, the protocol which defines the format of TB PPDU 206 may also be based on the protocol which defines the format of the PPDU 204 such as HE, EHT or NG-EHT and indicated in the preamble/PHY header 134 of the PPDU 132 by a field. In another example, the PPDU 204 may have an trigger frame 180 with a user information field 172 and AID12 subfield 174 to trigger solicitation of an HE TB PPDU or EHT TB PPDU. Additionally, or alternatively, the trigger frame 180 may have a user information field 172 with an AID12 subfield 174 which indicates solicitation of a EHT TB PPDU and which announces RUs which the solicited device is to use to send the EHT TB PPDU. Based on an OFDMA random access process described in more detail below, an STA which is not assigned to an RU may randomly select one of the RUs to transmit the TB PPDU.

### Trigger Response Scheduling of TB PPDU

In one example, the soliciting system 130 of an AP 102 may set the control ID field 152 of a soliciting PPDU to a value to indicate that a TB PPDU or PPDU which is not a TB PPDU is solicited from an STA 104-1 to 104-3. The protocol which defines a format of the TB PPDU may be based on EHT or NG-EHT and identified by a protocol which defines a format of the soliciting PPDU. The STA which receives the soliciting PPDU may provide a solicited PPDU which is indicated in response to the soliciting PPDU.

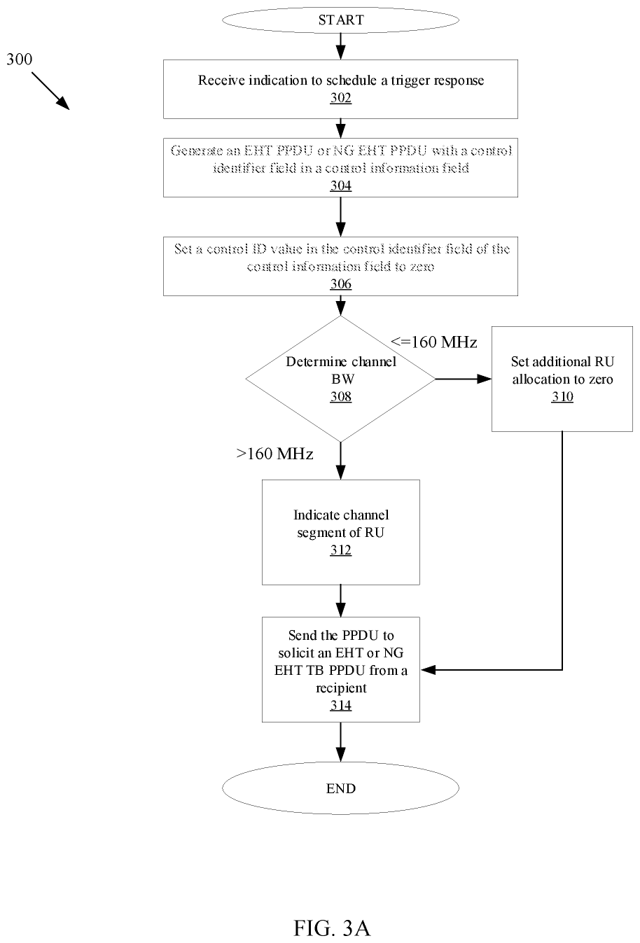

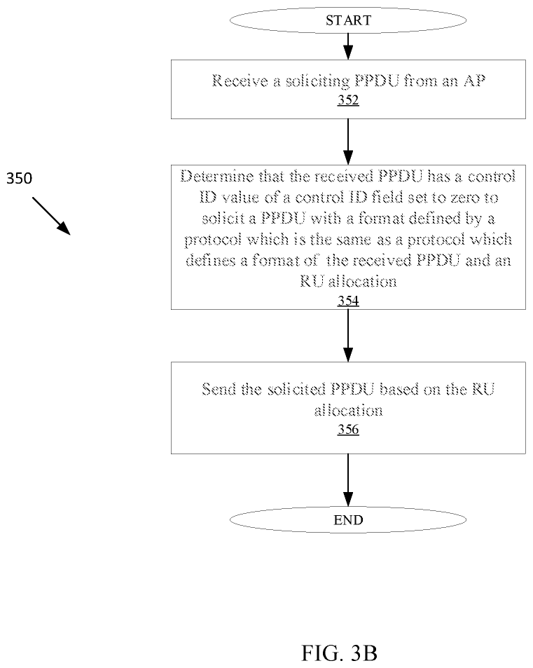

FIG. 3A illustrates a flow chart 300 of example functions tor soliciting a TB PPDU sent by the STA in accordance with an embodiment. The functions may be performed in part by the soliciting system 130 of the AP 102. In an example, the control ID 152 in the control information field 148 of a PPDU may indicate that the control information field 148 is associated with a TRS process and a TB PPDU is solicited

At 302, an indication to schedule a trigger response is received. In an example, the indication may be received by the soliciting system 130 of an AP 102 which causes the soliciting system 130 to generate a PPDU to solicit a TB PPDU.

At 304 an EHT PPDU or NG EHT PPDU associated with a single user (SU) where one STA is serviced at a time or multiple user (MU) transmission where multiple STA is serviced at a time is generated. The generated PPDU at 304 may have a control identifier field 152 in the control information field 148. At 306, a control ID value in the control identifier 152 of the control information field 148 in the PPDU is set to zero which indicates that the PPDU is associated with TRS. The control ID value set to zero may not explicitly indicate the protocol which defines a format of the TB PPDU solicited. Instead, the protocol of the TB PPDU solicited is EHT if the format of the soliciting PPDU is defined by EHT and NG HIT if the format of the soliciting PPDU is defined by NG EHT. For instance, in the event that the soliciting PPDU is an EHT SU PPDU or EHT MU PPDU, the TB PPDU may be an EHT TB PPDU. In the event that the soliciting PPDU is an NG EHT SU PPU or NG EHT MU PPDU, the TB PPDU may be an NG EHT TB PPDU.

The trigger based soliciting system 130 may also set the RU allocation field 156 and the additional RU allocation field 164 in the control information field to indicate the RU for the solicited TB PPDU ranges from 0 to 320 MHz. At 308, a determination is made whether a channel bandwidth (BW) of the solicited TB PPDU is no more than 160 MHz. The channel BW of the TB PPDU may be indicated in the MAC field 142 of the PPDU 132 or PHY header. If the channel 13W of the solicited TB PPDU is no more than 160 MHz, then at 310 the additional RU allocation 164 is set to 0. If the channel BW of the solicited TB PPDU is more than 160 MHz, then at 312 the additional RU allocation 164 may further indicate whether the RU is in a primary 160 MHz channel segment or secondary 160 MHz channel segment by a bit or the additional RU allocation 164 may further indicate whether the RU is in a lower 160 MHz channel segment or higher 160 MHz channel segment by a bit. The secondary 160 MHz channel segment is used to extend a bandwidth of the primary 160 MHz bandwidth to create a channel larger than 160 MHz. The lower 160 MHz channel segment or higher channel segment may specify a frequency range of the RU.

Other fields of the control information field 148 may be set in the NG EHT PPDU or EHT PPDU. The AP transmit power 158 may indicate a transmit power of the AP. The UL target RSSI 160 may be the RSSI the AP 102 wants to receive each non-AP STAs uplink transmission at. The UL MCS 162 may indicates the MCS, for example in the range MCS 0 to 3, to be used by the STA in sending the solicited PPDU. The UL data symbols field 154 may indicate the number of OFDM symbols in the data field of the solicited PPDU and is set to the number of OFDM symbols minus 1. After setting the fields of the control information field 148, at 314, the PPDU is sent to the STA which causes the STA to send the solicited PPDU in response to the soliciting PPDU.

FIG. 3B illustrates a flow chart 350 of example functions associated with the STA sending the solicited PPDU based on the AP performing the functions of FIG. 3A in accordance with an embodiment. At 352, the STA receives a soliciting PPDU from the AP 102. At 354, the STA may determine that the received PPDU has a control ID value of a control ID field set to zero to solicit a TB PPDU with a format defined by a same protocol which defines a format of the received PPDU and an RU allocation. At 556, the STA sends the solicited PPDU based on the RU allocation.

Instead of the protocol defining the format of the soliciting PPDU indicating the protocol defining a format of the TB PPDU, a control ID value in the control ID field 152 may explicitly indicate a protocol defining a format of the TB PPDU. The control ID value may indicate one of the EHT TB PPDU and NG EHT TB PPDU solicited. The STA which receives the soliciting PPDU may provide a solicited PPDU which is explicitly indicated in response to the soliciting PPDU.

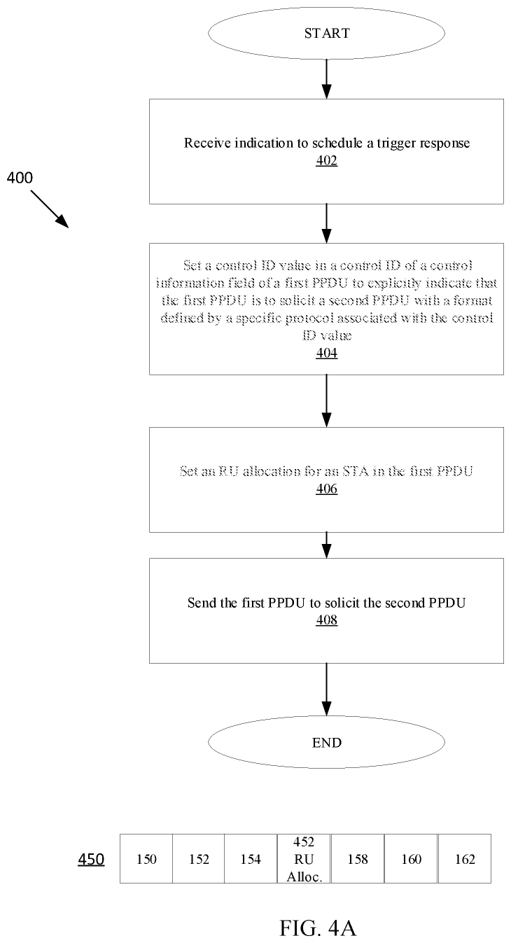

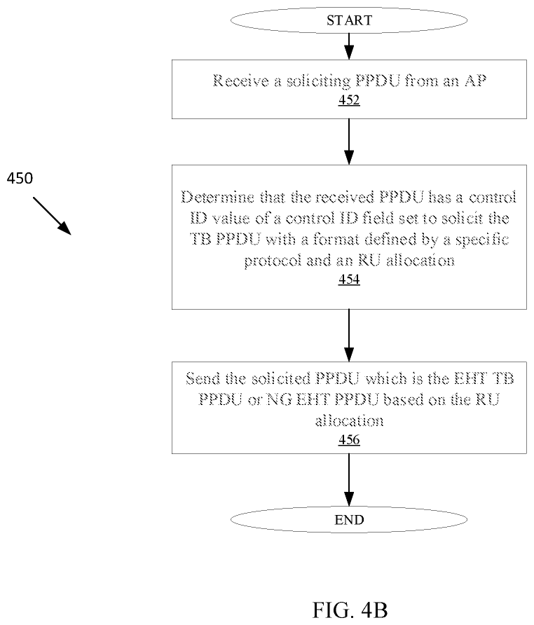

FIG. 4A illustrates a flow chart 400 of example functions associated with defining a control ID value of the control ID field 152 to solicit a format of TB PPDU from an STA in accordance with an embodiment. The functions may be performed in part by the soliciting system 130 of the AP 102.

At 402, an indication to schedule a trigger response is received. In an example, the indication may be received by the soliciting system 130 of an AP 102 which causes the soliciting system 130 to generate a first PPDU. The PPDU may have a control ID field 152 in the control information field 148. At 404, the control ID value in the control ID 152 of the control information field 148 of the first PPDU is set to explicitly indicate that the first PPDU is to solicit a second PPDU with a format defined by a specific protocol associated with the control ID value such as one of the EHT and NG EHT protocol to form one of an EHT TB PPDU and an NG EHT PPDU. For example, a first control ID value may indicate an EHT TB PPDU is solicited and a second control ID value different from the first control ID value may indicate that an NG EHT PPDU is solicited. The protocol defining the PPDU of the soliciting PPDU does not determine the protocol defining the format of the PPDU solicited in this example.

The PPDU with the control ID value may be in a DL EHT SU PPDU, EHT MU PPDU, NG EHT SU PPDU, or NG EHT MU PPDU. Alternatively, the PPDU with the control ID value may be in a DL PPDU other than DL EHT SU PPDU, EHT MU PPDU, NG EHT SU PPDU, or NG EHT MU PPDU.

At 406, the RU allocation for the STA is set in the first PPDU. The RU allocation may be set in many ways. In one example, the RU allocation may be arranged as nine bits in fields 156, 164 of the control information field 148. In another example, the control ID value set in the control ID field 152 may indicate that the control information field 148 may have a particular format. The format may be the control information field 148. Alternatively, the format may be a control information field 450 where the RU allocation may be defined as one field shown as 452 rather than fields 156, 164. One bit (MSB or LSB of RU allocation 452) may indicate the RU allocation. For example, when the 13W of the solicited TB PPDU is no more than 160 MHz, the bit may be set to 0 and when the BW of the solicited TB PPDU is more than 160 MHz, the bit may be set to 1. As another example, when the RU covers both two 160 MHz channel segments, the bit is set to f) and when the RU does not cover both two 160 MHz channel segments, the bit is set to 1. In yet another example, the bit is set to indicate the RU is in primary 160 MHz channel segment or secondary 160 MHz channel segment. In another example, the bit is set to indicate the RU is in lower 160 MHz channel segment or higher 160 MHz channel segment. The AP 102 and STA 104-1 to 104-3 may interpret the set bit as indicating whether the RU is in primary 160 MHz channel segment or secondary 160 MHz channel segment or in lower 160 MHz channel segment or higher channel segment based on a common understanding of what the bit represents between the AP and STA. Further, in an example, the trigger response scheduling system 130 may set the control information field 148 with indications of UL data symbols. AP Tx Power. UL Target RSSI, and UT MCS as described above. At 408, the first PPDU with the control information field 148 or 450 is sent to solicit the second PPDU which causes the STA to send an EHT or NG TB PPDU in response to the first PPDU.

FIG. 4B illustrates a flow chart 450 of example functions associated with the STA sending the solicited PPDU explicitly indicated based on the AP performing the functions of FIG. 4A in accordance with an embodiment. At 452, the STA receives a PPDU from the AP 102. At 454, the STA may determine that the received PPDU has a control ID value of the control ID field set to solicit the TB PPDU with a format defined by a specific protocol such as one of the EHT and NG EHT protocol to form one of an EHT TB PPDU or an NG EHT PPDU and an RU allocation. The control ID value may itself identify the format of the TB PPDU and other fields of the PPDU do not need to be considered to determine the format. For example, a first control ID value may indicate an EHT TB PPDU is solicited and a second control ID value different from the first control ID value may indicate that an NG EHT PPDU is solicited. At 456, the STA sends the solicited PPDU which is the HIT TB PPDU or NG EHT PPDU based on the RU allocation.

In some examples, the AP 102 may not be arranged to send a TB PPDU in response to a soliciting PPDU from an STA. Instead, the control ID field 152 in a soliciting PPDU may indicate that a PPDU which is not a TB PPDU is solicited. The STA which receives the soliciting PPDU may provide a solicited PPDU which is not a TB PPDU in response to the soliciting PPDU.

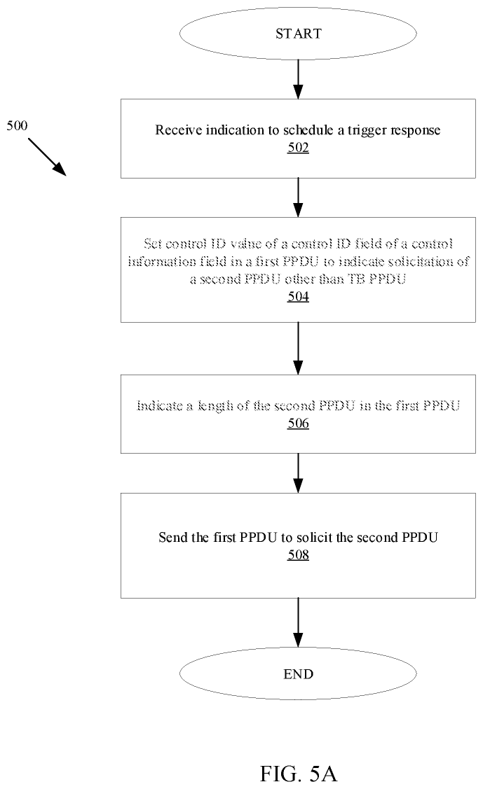

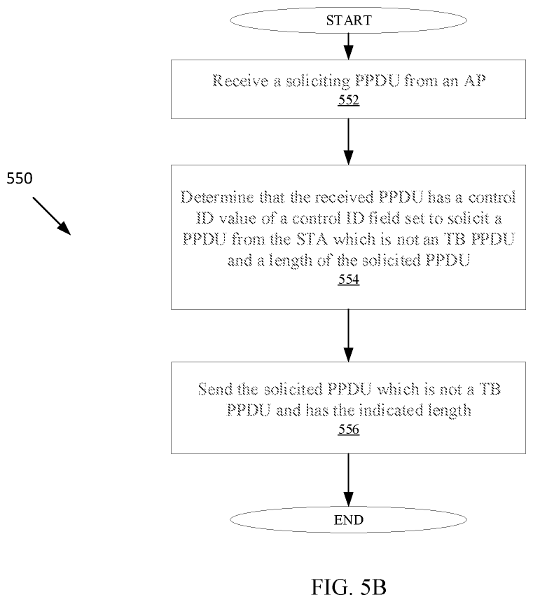

FIG. 5A illustrates a flow chart 500 of example functions associated with defining a control ID value of a control ID field 152 to solicit a PPDU from an STA which is not an TB PPDU in accordance with an embodiment. The functions may be performed in part by the soliciting system 130 of the AP 102.

At 502, an indication to schedule a trigger response is received. In an example, the indication may be received by the soliciting system 130 of an STA which causes the trigger response scheduling system 130 to generate a PPDU. The PPDU may have a control information field 148 with a control ID field 152. At 504, the control ID value of the control ID field 152 of the control information 550 in a first PPDU is set to explicitly and uniquely indicate solicitation of a second PPDU other than TB PPDU from an AP. At 506, a length of the second PPDU is indicated in the UL data symbols field 154 of the control information 148 of the PPDU. In other examples, the length may be indicated in a L-SIG field of the preamble of the solicited PPDU. At 508, the first PPDU is sent to solicit the second PPDU which causes a recipient such as the AP 102 or STA 14-1 to 104-3 to send the second PPDU in response to the first PPDU, which is not a TB PPDU. In an embodiment, the responding PPDU can be any format of PPDU that satisfies the length requirement.

In an example, the control ID value of the control ID field 152 may indicate that the UL MCS field 154 in the control information field 148 is an advised UL MCS and the STA may select another MCS. In an example, the first PPDU with the control ID field 152 may be in a DL/UL EHT SU PPDU, EHT MU PPDU, DL/UL NG EHT SU PPDU, NG EHT MU PPDU. In one example, the control ID value of the control ID field 152 may indicate that an EHT PPDU solicits EHT PPDU and the NG-EHT PPDU solicits NG-EHT PPDU. In another example, the control ID value of the control ID field 152 may indicate that the protocol which defines a format of the PPDU format is decided by the recipient of the PPDU. In yet another example, the control ID value of the control ID field 152 may indicate that the PPDU format is an advised PPDU format, and the solicited PPDU format is decided by the recipient of the soliciting PPDU.

FIG. 5B illustrates a flow chart 550 of example functions associated with the STA sending the solicited PPDU is not an TB PPDU based on the AP performing the functions of FIG. 5A in accordance with an embodiment. At 552, the STA receives a PPDU from the AP 102. At 554, the STA may determine that the received PPDU has a control ID value of a control ID field set to solicit a PPDU from the STA which is not an TB PPDU and a length of the solicited PPDU. At 556, the STA sends the solicited PPDU which is not a TB PPDU and has the indicated length.

Triggering EHT TB PPDU with Announcement of OFDMA Random Access RUs

The PPDU with the control information field 148 may solicit an TB PPDU which is an EHT TB PPDU or NG EHT TB PPDU. As an alternative to soliciting the TB PPDU based on the control information field 148 in a data frame or management frame, an AP 102 or STA 104-1 to 104-3 may solicit an EHT TB PPDU by transmitting the trigger frame 180 in the PPDU 132.

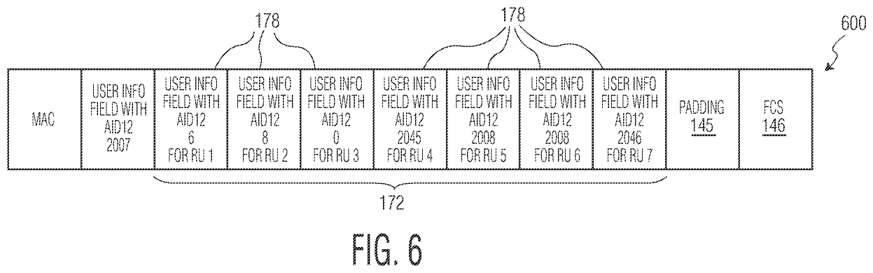

FIG. 6 illustrates an example trigger frame 600 which is transmitted to solicit one or more HE TB PPDU and EHT TB PPDU in accordance with an embodiment. The trigger frame 600 may have a plurality of fields for soliciting the EHT TB PPDU and announce random access RUs to transmit the TB PPDU. The plurality of fields may include the user information list field 172 which comprises one or more user information fields 178. The trigger frame 600 may have eight information fields 178 in this example. The user information field 178 may have the AID12 subfield and an RU allocation subfield. In an example, an AID12 subfield may be set to 2007 to indicate that the frame is an EHT trigger which triggers solicitation of a PPDU and the RU allocation subfield is redefined. An AID12 subfield may have an AID12 value of 1 to 2006 (such as AID12=6 or AID12=8) to indicate solicitation of a HE TB PPDU from an STA with the AID12 value using the identified RU (e.g., RU1, RU2) if there is no user information field 178 with 2007 in AID12 subfield, or solicitation of an EHT TB PPDU if there is user information field 178 with 207 in AID12 subfield. Alternatively, an AID12 subfield may be set to 0 to indicate that an associated STA may randomly select the announced RU (e.g., RU3) to transmit a HE TB PPDU while an AID12 subfield may be set to 2045 to indicate that an unassociated STA may randomly select the announced RU (e.g., RU4) to transmit a HE TB PPDU. If the STA is associated with the AP, the STA may randomly select the RU associated with the user information subfield 178 having AID12=0. If the STA is unassociated with the AP, the STA may randomly select the RU associated with the user information subfield 178 having AID12=2045. The STA may be associated if the STA and AP are connected as a result of a probe request and response process and unassociated if the STA and AP are not connected as a result of a probe request and response process. Further, the user information field 178 with AID12=2007 may be before the user information field 178 with AID12 of 0 or 2045.

In an example, the trigger frame 600 may be arranged to solicit an EHT TB PPDU by including one user information field 178 in the trigger frame with AID12 field equal to 2007. The AID12 subfield of one of the user information subfield 178 other than 2007 may typically indicate that an STA associated with the AID12 value in the user information subfield 178 with AID12 subfield may use an identified RU in the RU allocation field of the same user information subfield 178 to send the EHT TB PPDU. Since the user information field with AID12 subfield equal to 0 or 2045 is addressed to multiple STAs, a HE STA may treat the user information field with AID12 subfield equal to 0 or 2045 as the field to define the random-accessed RU for HE PPDU. To solicit an EHT TB PPDU through random access RU, the AID12 value of the user information subfield 178 with AID12 subfield may be selected from 2008 to 2044 where one value may indicate that an announced RU may be randomly selected by an associated STA to transmit an EHT TB PPDU while the user information subfield 178 with AID12 subfield may be set to another value to indicate that an announced RU may be randomly selected by an unassociated STA to transmit an EHT TB PPDU. For example, the trigger frame 600 may have a user information subfield 178 with AID12 subfield with an AID12 value of 2008 and RU5 which is announced. In other examples, a single AID12 value from 2008 to 2044 may be used to indicate an announced RU to be randomly selected by both associated STAs and unassociated STAs. In an example, the AID12 value in a user information subfield 178 with AID12 subfield of the trigger frame 600 which solicits the EHT TB PPDU may be referred to as a EhtTbRandomAID variable. The EhtTbRandomAID variable may not distinguish between whether the RU associated with the EhtTbRandomAID variable (e.g., in a same user information field 178) is to be randomly selected by an unassociated STA or associated STA. In another example, a variable EhtTbRandomAIDForUnassociatedSta may indicate that the RU associated with the EhtTbRandomAIDForUnassociatedSta variable (e.g., both variable and RU are in a same user information field 178) is to be randomly selected by an unassociated STA and a variable EhtTbRandomAIDForAssociatedSta may indicate that the RU associated with the EhtTbRandomAIDForAssociatedSta variable (e.g., both variable and RU are in a same user information field 178) is to be randomly selected by an associated STA.

The AID12 values in the user information subfield 178 with AID12 subfields may be arranged in the user information fields 178 in a particular order. In an example, the user information field 178 with AID subfield having AID12 value of EhtTbRandomAID may be after the user information fields 178 with AID12 values of 1 to 2007. Further, the user information field 178 with AID subfields having AID12 values of EhtTbRandomAID may be before the user information fields 178 with AID12 value of 2046. The AID12 value=2046 may indicate an RU identified in the user information field 178 with the AID12 value=2046 is not to be used. If the trigger frame 60) solicits both EHT TB PPDU and HE TB PPDU, then the user info fields 178 with AID12 values of EhtTbRandomAID may be after the user info fields 178 with AID12 values of 0 and 2045 associated with soliciting the HE PPDU. Further, the user information field 178 with AID subfield having AID12 values of EhtTbRandomAID may be before the user info fields 178 with AID12 values of 2046.

In an example, an STA may use an OFDMA back off (OBO) procedure to transmit the TB PPDU in an RU. An OBO counter in an STA may be initialized to a random value which may be equiprobably drawn from a set of (0, 1, . . . OCW−1) where OCW is an OFDMA contention window (OCW). When the STA receives a trigger frame 180, the OBO counter may be compared to the number of RUs allocated in the user information fields 172 of the trigger frame 180. If the OBO counter is greater than the number of RUs, the STA decreases its OBO counter by the number of RUs allocated and waits for the next trigger frame 180. Otherwise, the STA randomly selects an RU allocated to send the EHT TB PPDU.

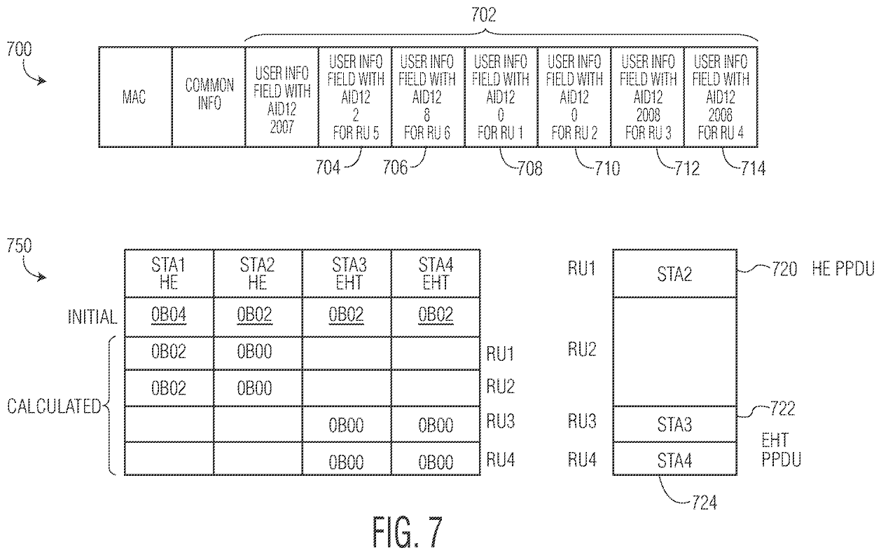

FIG. 7 illustrates an example operation of STAs which randomly access RUs in accordance with an embodiment. A trigger frame 700 may have a plurality of user information fields 702. In an example, a user information field 704, 706 with AID12 subfield may have an AID12 value which is between 1 and 2006 such as 2 and 8 respectively which indicate that an RU indicated in the corresponding user information field is associated with a specific STA with the AID12 value. The STAs associated with those AID12 values may use the indicated RU in the corresponding user information field with AID12 subfield to transmit a TB PPDU. In an example, a user information field 708, 710 with AID12 subfield may have an AID12 value which is 0 or 2045 to announce RUs identified in the corresponding user information field which are to be randomly assigned to carry HE TB PPDU. In an example, the user information field with AID12 subfield having AID12 value between 1 and 2006 associated with soliciting a HE TB PPDU or the AID12 value 0/2045 also associated with soliciting a HE TB PPDU may precede user information fields 712, 714 with AID12 subfields associated with soliciting an EHT TB PPDU. The user information field 712, 714 with AID12 subfield may have an AID12 value which is between 2008 and 2044 to announce RUs identified in the corresponding user information field which are to be randomly assigned to carry EHT TB PPDU. In this example, four RUs may be randomly assigned where two user information fields 708, 710 with AID12 subfield are associated with AID12 value of 0 and two user information fields 712, 714 are associated with AID12 value of 2008.

In an example, the STA to transmit an EHT TB PPDU may randomly select the RUs associated with a user information field with AID12 subfield having a same AID12 value. The selection process may include determining whether an OBO) counter associated with an STA is zero after being reduced by the number of available RUs. If the OBO counter is zero, then the EHT TB PPDU is sent. If the OBO counter is not zero, then the EHT TB PPDU is not sent. In an example, STA1 has an OBO value of 4, STA2 has an OBO value of 2, STA3 has an OBO value of 2, and STA4 has an OBO value of 2 when the trigger frame 180 is received as shown by table 750. Further, STA1 and STA2 may support HE while STA 3 and STA 4 may support EHT. The OBO counter of STA1 and STA 2 may be reduced by 2 because two RUs are available with AID12=0 values and STA2 which supports HE may transmit a HE TB PPDU 720 in RU1 randomly selected. The OBO counter of STA3 and STA 4 may be reduced by 2 because two RUs are available with AID12=2008 values and STA 3 and STA 4 which support EHT may transmit an EHT TB PPDU 722, 724 in RU3 and RU4 randomly selected. In some examples, an STA may further transmit the EHT TB PPDU if the RU selected is in an operating channel (e.g., channel selected through a subchannel selective transmission (SST) operation such as channel in a primary or secondary channel) or the STA supports transmit parameters of the RU. Otherwise, the EHT STA may randomly select the RU defined by the user information field 178 with AID12 value of 0/2045.

In some examples, an unassociated STA may not be able to acknowledge an association response in a trigger frame 180 from an AP 102 unicast to the unassociated STA because an OBO value may be too large and not be zero to randomly select an RU. To allow the unassociated STA to send the acknowledgement, the STA may be allowed to select an RU without consideration of the OBO value.

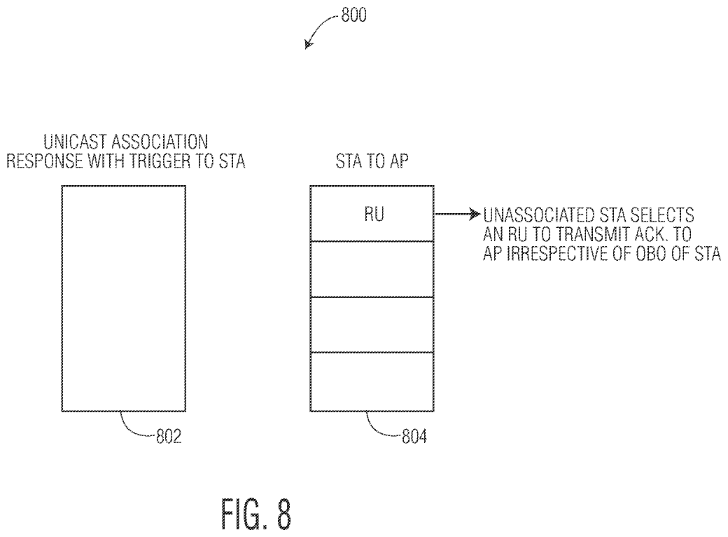

FIG. 8 illustrates an example operation 800 of an unassociated STA which receives a unicast association response with a trigger 802 and transmits an acknowledgement 804 to the association response in accordance with an embodiment. The trigger frame 802 may include a recipient address (RA) identifying the unassociated STA to which the trigger frame 802 is unicast and an indication to transmit an acknowledgement. The trigger frame 800 may also announce one or more RUs by User Info field(s) with AID12 equal to EhtTbRandomAIDForUnassociatedSta. When a Trigger frame 802 has individual-addressed RA and announces one or more RUs by User Info field(s) with AID12 equal to EhtTbRandomAIDForUnassociatedSta the STA whose address is equal to individual-addressed RA selects one RU to transmit its frame, e.g. Ack 804. The OBO value of the OBO counter of the STA may not affect selection of the RU.

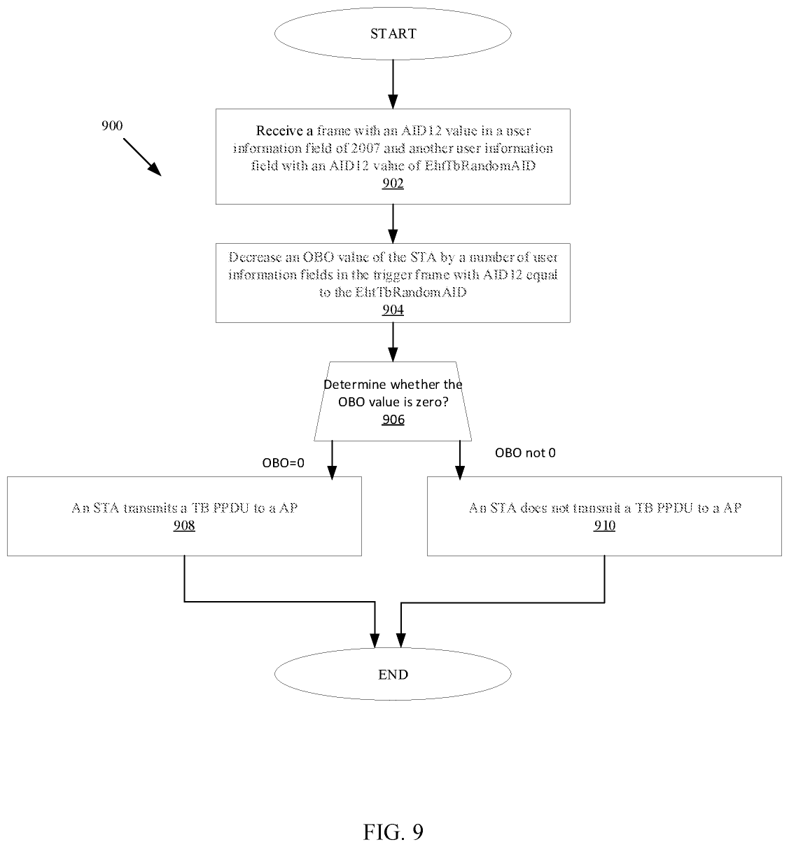

FIG. 9 illustrates a flow chart 900 of example functions associated with soliciting an EHT TB PPDU based on the trigger frame 180 in accordance with an embodiment. In an example, the functions may be performed by a STA which receives the trigger frame 180 from the AP 102.

At 902, a frame with an AID12 value in a user information field of 2007 and another user information field with an AID12 value of EhtTbRandomAID is received. The AID12 value of 2007 may indicate that the frame is a trigger frame. The other user information field with the AID12 value of EhtTbRandomAID which is between 2008 and 2044 may indicate that the soliciting device such as an AP 102 is soliciting a EHT TB PPDU from an STA. The trigger frame may have one or more user information fields each with an AID12 of the EhtTbRandomAID and an RU allocated to transmit a EHT TB PPDU. At 904, an OBO value of the STA may be decreased by the number of user information fields in the trigger frame with AID12 equal to the EhtTbRandomAID. At 906, a determination is made whether the OBO value is zero. If the OBO value is zero, then at 908, the STA transmits a TB PPDU to the AP 102. The TB PPDU may be transmitted in an RU randomly selected from those RUs in the information fields with AID12 of the EhtTbRandomAID in the trigger frame 180. If the OBO value is not zero, then at 910, the STA does not transmit a TB PPDU to the AP 102.

In an embodiment, a method for transmitting a first data unit and receiving a second data unit is disclosed. The method comprises: transmitting the first data unit which indicates to a remote device to transmit the second data unit, wherein the first data unit comprises a value which indicates that the remote device is to transmit the second data unit and does not indicate a protocol which defines a format of the second data unit, wherein the protocol which defines the format of the second data unit is based on a protocol which defines a format of the first data unit; and receiving from the remote device the second data unit in response to the transmission of the first data unit. In an example, based on the value the protocol which defines the format of the second data unit is to be the same as the protocol which defines the format of the first data unit. In an example, the value is a first value; and wherein the first data unit comprise one of the first value and a second value, the second value indicates that the remote device is to transmit the second data unit and indicates the protocol which defines the format of the second data unit, the second value is a control identification in a control information field of the first data unit. In an example, a bit of a resource unit (RU) allocation field of the control information field indicates an RU bandwidth of the second data unit is more than 160 MHz. In an example, the first data unit is a trigger frame or physical layer convergence protocol data unit (PPDU) and the second data unit is a trigger based (TB) PPDU. In an example, the second value is in an association identification 12 (AID12) field of a user information field of the trigger frame which comprises an AID12 value from 2008 to 2044. In an example, the second value further indicates that the remote device is to randomly select an RU to transmit the second data unit based on an OFDMA back off (OBO) counter of the remote device reaching zero. In an example, the RU selected is from a plurality of RUs identified by a plurality of information fields in the trigger frame with the second value. In an example, the protocol which defines the format of the first data unit is indicated in a physical layer header of the first data unit. In an example, the protocol defining the format of the second data unit is one of an extremely high throughput (EHT) and next generation (NG) EHT protocol.

In another embodiment, an access point (AP) is disclosed. The AP comprises: first circuitry configured to transmit a first data unit which indicates to a remote device to transmit a second data unit, wherein the first data unit comprises a value which indicates that the remote device is to transmit the second data unit and does not indicate a protocol which defines a format of the second data unit, wherein the protocol which defines the format of the second data unit is based on a protocol which defines a format of the first data unit; and second circuitry configured to receive from the remote device the second data unit in response to the transmission of the first data unit. In an example, based on the value the protocol which defines the format of the second data unit is to be the same as the protocol which defines the format of the first data unit. In an example, the value is a first value; and wherein the first data unit comprise one of the first value and a second value, the second value indicates that the remote device is to transmit the second data unit and indicates the protocol which defines the format of the second data unit, the second value is a control identification in a control information field of a data frame. In an example, a bit of a resource unit (RU) allocation field of the control information field indicates an RU bandwidth of the second data unit is more than 160 MHz. In an example, the first data unit is a trigger frame or physical layer convergence protocol data unit (PPDU) and the second data unit is a trigger based (TB) PPDU. In an example, the second value is in an association identification 12 (AID12) field of a user information field of a trigger frame which comprises an AID12 value from 2008 to 2044. In an example, the second value further indicates that the STA is to randomly select an RU to transmit the second data unit based on an OFDMA back off (OBO) counter of the STA reaching zero. In an example, the remote device is further arranged with circuitry to select the RU from a plurality of RUs defined by a plurality of information fields in the trigger frame with the second value. In an example, the protocol which defines the format of the first data unit is indicated in a preamble of the first data unit. In an example, the protocol which defines the format of the second data unit is based on an extremely high throughput (EHT) or next generation EHT protocol.

In yet another embodiment, a method is disclosed. The method comprises receiving a first data unit which indicates to a remote device to transmit a second data unit, wherein the first data unit comprises a value which indicates that the remote device is to transmit the second data unit and does not indicate a protocol which defines a format of the second data unit, wherein the protocol which defines the format of the second data unit is based on a protocol which defines a format of the first data unit; and transmitting from the remote device the second data unit in response to the reception of the first data unit. In an example, based on the value the protocol which defines format of the second data unit is to be the same as the protocol which defines the format of the first data unit. In an example, the value is a first value; and wherein the first data unit comprise one of the first value and a second value which indicates that the remote device is to transmit the second data unit and indicates the protocol which defines the format of the second data unit, the second value is a control identification in a control information field of the first data unit. In an example, the second value further indicates that the remote device is to randomly select an RU to transmit the second data unit based on an OFDMA back off (OBO) counter of the STA reaching zero. In an example, the RU selected is from a plurality of RUs identified by a plurality of information fields in the first data unit.

A few implementations have been described in detail above, and various modifications are possible. The disclosed subject matter, including the functional operations described in this specification, can be implemented in electronic circuitry, computer hardware, firmware, software, or in combinations of them, such as the structural means disclosed in this specification and structural equivalents thereof: including potentially a program operable to cause one or more data processing apparatus such as a processor to perform the operations described (such as program code encoded in a non-transitory computer-readable medium, which can be a memory device, a storage device, a machine-readable storage substrate, or other physical, machine readable medium, or a combination of one or more of them).

While this specification contains many specifics, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

Other implementations fall within the scope of the following claims.

What is claimed is:

1. A method for transmitting a first data unit and receiving a second data unit comprising:
transmitting the first data unit which indicates to a remote device to transmit the second data unit, wherein the first data unit comprises a value which indicates that the remote device is to transmit the second data unit and does not indicate a protocol which defines a format of the second data unit, wherein the protocol which defines the format of the second data unit is based on a protocol which defines a format of the first data unit; and
receiving from the remote device the second data unit in response to the transmission of the first data unit.

2. The method of claim 1, wherein based on the value the protocol which defines the format of the second data unit is to be the same as the protocol which defines the format of the first data unit.

3. The method of claim 1, wherein the value is a first value; and wherein the first data unit comprise one of the first value and a second value, the second value indicates that the remote device is to transmit the second data unit and indicates the protocol which defines the format of the second data unit, the second value is a control identification in a control information field of the first data unit.

4. The method of claim 3, wherein a bit of a resource unit (RU) allocation field of the control information field indicates an RU bandwidth of the second data unit is more than 160 MHz.

5. The method of claim 3, wherein the first data unit is a trigger frame or physical layer convergence protocol data unit (PPDU) and the second data unit is a trigger based (TB) PPDU.

6. The method of claim 5, wherein the second value is in an association identification 12 (AID12) field of a user information field of the trigger frame which comprises an AID12 value from 2008 to 2044.

7. The method of claim 6, wherein the second value further indicates that the remote device is to randomly select an RU to transmit the second data unit based on an OFDMA back off (OBO) counter of the remote device reaching zero.

8. The method of claim 7, wherein the RU selected is from a plurality of RUs identified by a plurality of information fields in the trigger frame with the second value.

9. The method of claim 1, wherein the protocol which defines the format of the first data unit is indicated in a physical layer header of the first data unit.

10. The method of claim 1, wherein the protocol defining the format of the second data unit is one of an extremely high throughput (EHT) and next generation (NG) EHT protocol.

11. An access point (AP) comprising:
first circuitry configured to transmit a first data unit which indicates to a remote device to transmit a second data unit, wherein the first data unit comprises a value which indicates that the remote device is to transmit the second data unit and does not indicate a protocol which defines a format of the second data unit, wherein the protocol which defines the format of the second data unit is based on a protocol which defines a format of the first data unit; and
second circuitry configured to receive from the remote device the second data unit in response to the transmission of the first data unit.

12. The communication device of claim 11, wherein based on the value the protocol which defines the format of the second data unit is to be the same as the protocol which defines the format of the first data unit.

13. The communication device of claim 11, wherein the value is a first value; and
wherein the first data unit comprise one of the first value and a second value, the second value indicates that the remote device is to transmit the second data unit and indicates the protocol which defines the format of the second data unit, the second value is a control identification in a control information field of a data frame.

14. The communication device of claim 13, wherein a bit of a resource unit (RU) allocation field of the control information field indicates an RU bandwidth of the second data unit is more than 160 MHz.

15. The communication device of claim 13, wherein the first data unit is a trigger frame or physical layer convergence protocol data unit (PPDU) and the second data unit is a trigger based (TB) PPDU.

16. The communication device of claim 15, wherein the second value is in an association identification 12 (AID12) field of a user information field of a trigger frame which comprises an AID12 value from 2008 to 2044.

17. The communication device of claim 16, wherein the second value further indicates that the STA is to randomly select an RU to transmit the second data unit based on an OFDMA back off (OBO) counter of the STA reaching zero.

18. The communication device of claim 17, wherein the remote device is further arranged with circuitry to select the RU from a plurality of RUs defined by a plurality of information fields in the trigger frame with the second value.

19. The communication device of claim 17, wherein the protocol which defines the format of the first data unit is indicated in a preamble of the first data unit.

20. The communication device of claim 17, wherein the protocol which defines the format of the second data unit is based on an extremely high throughput (EHT) or next generation EHT protocol.

21. A method comprising:
receiving a first data unit which indicates to a remote device to transmit a second data unit, wherein the first data unit comprises a value which indicates that the remote device is to transmit the second data unit and does not indicate a protocol which defines a format of the second data unit, wherein the protocol which defines the format of the second data unit is based on a protocol which defines a format of the first data unit; and
transmitting from the remote device the second data unit in response to the reception of the first data unit.

22. The method of claim 21, wherein based on the value the protocol which defines format of the second data unit is to be the same as the protocol which defines the format of the first data unit.

23. The method of claim 21, wherein the value is a first value; and wherein the first data unit comprise one of the first value and a second value which indicates that the remote device is to transmit the second data unit and indicates the protocol which defines the format of the second data unit, the second value is a control identification in a control information field of the first data unit.

24. The method of claim 23, wherein the second value further indicates that the remote device is to randomly select a resource unit (RU) to transmit the second data unit based on an OFDMA back off (OBO) counter of the STA reaching zero.

25. The method of claim 24, wherein the RU selected is from a plurality of RUs identified by a plurality of information fields in the first data unit.
